(19) United States
(12) Patent Application Publication
(10) Pub. No.: US 2026/0246505 A1
(43) Pub. Date: Aug. 20, 2026

(54) COMPUTER SYSTEM, METHOD PERFORMED BY COMPUTER SYSTEM, AND PROGRAM

(71) Applicant: NEC Corporation, Tokyo (JP)

(72) Inventors: Daichi SHIRASE, Tokyo (JP); Kazushi MURAOKA, Tokyo (JP); Toshiki TAKEUCHI, Tokyo (JP)

(73) Assignee: NEC Corporation, Tokyo (JP)

(21) Appl. No.: 19/160,500

(22) PCT Filed: Feb. 21, 2024
(86) PCT No.: PCT/JP2024/006191

§ 371 Date: Aug. 28, 2025

(30) Foreign Application Priority Data
Mar. 7, 2023 (JP) 2023-034256

(51) Int. Cl. H04B 7/0452

(52) U.S. Cl. CPC H04B 7/0452

(57) ABSTRACT

A computer system provides an environment in which an application for providing a radio access network function runs, and receives from the application, in a request to offload a weight calculation processing, data and information required for the weight calculation processing to be processed by a hardware (HW) accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element. For example, this contributes to providing an implementation suitable for offloading some of the processing of a partial weight generation method to an HW accelerator.

### TECHNICAL FIELD

The present disclosure relates to radio communication systems, and more particularly to signal processing for transmitting and receiving in a radio access network element (e.g., a base station) communicating with a plurality of radio terminals.

### BACKGROUND ART

Massive multiple-input multiple-output (MIMO) is a physical layer technology used in the 3rd Generation Partnership Project (3GPP (registered trademark)) Fifth Generation (5G) system. In Massive MIMO (mMIMO) technology, a cellular network base station (i.e., gNB in a 5G system) uses an antenna array with multiple antennas. An antenna array is used for digital beamforming and, in particular, for spatial multiplexing of a large number of radio terminals (User Equipments (UEs)) on the same time and frequency resources. A key feature of mMIMO is that a base station has more antennas than the number of UEs in a cell, compared to existing multi-user MIMO. Spatially distributed antenna arrays may be located within a single cell served by a base station.

One of the key technologies for Beyond 5G or 6G is distributed MIMO. The fundamental concept of distributed MIMO is to use a relatively large number of antennas spread across a broad area to serve a relatively small number of UEs (see, for example, Non-Patent Literature 1 and 2). Each of the distributed antennas is connected to a network element responsible for digital baseband signal processing via a fronthaul connection. The network element responsible for digital baseband signal processing is referred to, for example, as a baseband unit, digital unit, distributed unit (DU), central processing unit (CPU), or edge cloud processor. Distributed MIMO is also referred to as cell-free massive MIMO or a distributed antenna system (DAS). Each distributed antenna is also referred to as a transmission and reception point (TRP), radio unit (RU), remote radio head, or access point (AP). Hereafter, each distributed antenna will be referred to as an AP.

Similar to existing centralized MIMO (or network MIMO), distributed MIMO enables multi-user MIMO (MU-MIMO) transmission, which communicates with multiple UEs spatially multiplexed on the same time and frequency resources. An MU-MIMO base station digitally combines signals using precoding weights and postcoding weights during downlink transmission and uplink reception, respectively. Postcoding weights are sometimes referred to as combining weights, receiving combining weights, reception weights, or spatial filtering weights. Hereinafter, the terms “precoding weights” and “postcoding weights” will be collectively referred to as “weights.”

In distributed MIMO using a large number of distributed APs, the number of APs or antennas connected to a base station and the number of UEs spatially multiplexed are expected to increase compared to those in centralized MIMO. This increases the processing load for weight generation or calculation at the base station. Non-Patent Literature 1 proposes minimum mean-squared error (MMSE) combining and zero-forcing (ZF) combining methods for receiving uplink signals from UEs in distributed MIMO. However, the computational complexity of the inverse matrix calculation, which is necessary for weight calculation based on the MMSE criterion, is of the order of the cube of the number of APs or antennas. Similarly, that based on the ZF criterion is of the order of the cube of the number of UEs.

Non-Patent Literature 2 proposes a method for reducing the amount of computation required for weight calculation. In the method proposed in Non-Patent Literature 2, a network element (e.g., a baseband unit) responsible for digital baseband signal processing selects a subset (or cluster) from multiple UEs communicating with a base station, and further selects a subset (or cluster) of antennas from multiple antennas of the base station to serve the selected subset of UEs. Hereinafter, the combination of the subset of selected UEs and the subset of selected antennas serving the selected UEs will be referred to as a “subsystem.” The network element generates ZF or MMSE weights per subsystem. This reduces the computational load required for the inverse matrix calculation in weight generation. Additionally, the base station may further select UEs (interfering UEs) to be considered as interference sources in the calculation of the weights for each subsystem. In this case, a single subsystem is a combination of a subset of selected UEs, a subset of selected antennas that serve these selected UEs, and a subset of interfering UEs. Hereafter, the method in which a network element responsible for digital baseband signal processing calculates weights on a per-subset basis, such as described in Non-Patent Literature 2, is referred to as the “partial or local weight generation method.” Conversely, the method in which a network element responsible for digital baseband signal processing calculates weights by considering all of the antennas connected to the network element and all of the UEs served by these multiple antennas collectively is referred to as the “global weight generation method.”

Meanwhile, organizations such as the European Telecommunications Standards Institute (ETSI) and the Open RAN (O-RAN) Alliance are working to standardize virtualization technologies for radio access network (RAN) functions. These virtualization techniques decouple the hardware and software of RAN network components (e.g., gNB Central Unit (CU), gNB Distributed Unit (DU), and Radio Unit (RU)), and deploy the software components on a generic server. The running environment in which virtualized RAN network function applications run is referred to as a virtualization platform or cloud platform, for example. The hardware of a virtualization or cloud platform is augmented with hardware (HW) accelerators as needed.

A virtualization or cloud platform is a collection of hardware and software components that provide the computing capabilities to perform virtualized RAN network functions. The hardware of a virtualization or cloud platform includes computing, networking, and storage components, and may also include various acceleration technologies required by RAN network functions to achieve their performance goals. The software of a virtualization or cloud platform provides Application Programming Interfaces (APIs) to manage the lifecycle of virtualized RAN network functions. A virtualization or cloud platform may use virtual machines (VMs) orchestrated and managed with OpenStack (registered trademark) or containers orchestrated and managed with Kubernetes (registered trademark), or both, to implement virtualized (or containerized or cloudified) RAN networking functions.

As mentioned above, a virtualization or cloud platform's hardware can be augmented with HW accelerators as needed. HW accelerators may be programmable or non-programmable circuits or devices. Examples of HW accelerators include field-programmable gate arrays (FPGAs), graphical processing units (GPUs), digital signal processors (DSPs), and application-specific integrated circuits (ASICs). A virtualization or cloud platform enables RAN network functional applications running thereon to offload computing tasks to HW accelerators, and provides interfaces (i.e., APIs) for these applications to utilize the HW accelerators. These interfaces are referred to as Acceleration Abstraction Layer (AAL) interfaces.

The O-RAN Alliance is a community of mobile operators, vendors, and research and academic institutions, and its mission is to re-shape radio access networks (RANs) to be more intelligent, open, virtualized and fully interoperable. The O-RAN Working Group 6 (WG6) defines the O-Cloud platform, which is an example of a virtualization or cloud platform described above (see, for example, Non-Patent Literature 3-7). The O-Cloud platform is also referred to as simply O-Cloud.

Non-Patent Literature 4-7 provides technical specifications for the O-Cloud Acceleration Abstraction Layer (AAL) and AAL-related APIs. The AAL is used to assist in the portability of application software. One of the roles of the AAL is to provide common interfaces (i.e., APIs) for use by virtualized RAN network functions, independent of underlying accelerators. Implementations or instances of the AAL include, but are not limited to, software libraries, device drivers, and HW accelerators necessary to realize the AAL.

The APIs provided by the O-Cloud AAL consist of two distinct parts. The first part corresponds to a set of common APIs (AALI-C), which address all aspects independently of the profiles of the underlying AAL implementation in the O-Cloud platform (see, for example, Non-Patent Literature 4 and 5). There are two categories of AALI-C interfaces: AALI-C-Mgmt and AALI-C-App. The AALI-C-Mgmt is provided by the Accelerator Manager to the O-Cloud Infrastructure Management Service (IMS) for common management operations, actions, and events. The AALI-C-App, meanwhile, is provided by the AAL to RAN network function applications for common operations, actions, and events.

The second part of the APIs provided by the O-Cloud's AAL corresponds to a set of AAL Profile Specific APIs (AALI-P), which depend on each defined AAL profile (see, for example, Non-Patent Literature 4, 6, and 7). The AAL profiles currently defined by the O-RAN WG6 include, along with other profiles, the AAL profile for MU-MIMO beamforming (precoding) weight calculations (i.e., AAL_MU-MIMO_PRECODER_WEIGHTS_CALC profile), and the AAL profiles (i.e., AAL_PDSCH_FEC profile and AAL_PUSCH_FEC profile) for forward error correction (FEC) calculations for downlink and uplink physical channels. Non-Patent Literature 6 specifies the detailed parameters of the AAL_MU-MIMO_PRECODER_WEIGHTS_CALC profile. Non-Patent Literature 7 specifies the detailed parameters of the AAL_PDSCH_FEC profile and the AAL_PUSCH_FEC profile. According to Non-Patent Literature 6, the parameters sent from an application to the AAL or an HW accelerator include an ordered list of UEs selected for scheduling, the number of scheduled layers per UE, and estimated channel information. The HW accelerator calculates beamforming weights for the selected UEs and layers based on, for example, block diagonalization based precoding. The parameters sent to the application from the HW accelerator or the AAL include the beamforming (precoding) weights per Precoding Resource Block Group (PRG) for the layers of the selected UEs.

### CITATION LIST

### Non Patent Literature

[Non-Patent Literature 1] E. Bjornson and L. Sanguinetti, “Making Cell-Free Massive MIMO Competitive With MMSE Processing and Centralized Implementation,” IEEE Transactions on Wireless Communications, vol. 19, no. 1, pp. 77-90, January 2020
[Non-Patent Literature 2] Ryo TAKAHASHI, Hidenori MATSUO, Sijie Xia, Qiang Chen, and Fumiyuki ADACHI, “A Study on Uplink Postcoding in User-Centric and User-Cluster-Centric CF-mMIMO,” IEICE Technical Report, vol. 122, no. 73, RCS2022-26, pp. 13-18, June 2022
[Non-Patent Literature 3] O-RAN ALLIANCE Working Group 6, “O-RAN Cloud Architecture and Deployment Scenarios for O-RAN Virtualized RAN 4.0,” O-RAN.WG6.CADS-v04.00, October 2022
[Non-Patent Literature 4] O-RAN ALLIANCE Working Group 6, “O-RAN Acceleration Abstraction Layer General Aspects and Principles 4.0,” O-RAN. WG6. AAL-GAnP.0-v04.00, October 2022
[Non-Patent Literature 5] O-RAN ALLIANCE Working Group 6, “O-RAN Acceleration Abstraction Layer Common API 2.0,” O-RAN.WG6.AAL-Common-API.0-v02.00, October 2022
[Non-Patent Literature 6] O-RAN ALLIANCE Working Group 6, “O-RAN Acceleration Abstraction Layer AAL Profile—MUMIMO Precoder/BeamFormer Calculation 1.0,” O-RAN. WG6. AAL-MUMIMO-BF-Calc-Profile-v01.00, July 2022
[Non-Patent Literature 7] O-RAN ALLIANCE Working Group 6, “O-RAN Acceleration Abstraction Layer FEC Profiles 3.0,” O-RAN.WG6.AAL-FEC.0-v03.00, October 2022
[Non-Patent Literature 8] Mark J. van der Laan, Katherine S. Pollard, and Jennifer Bryan, “A New Partitioning Around Medoids Algorithm,” U.C. Berkeley Division of Biostatistics Working Paper Series, Working Paper 105, February 2002

### SUMMARY OF INVENTION

### Technical Problem

The inventors have studied the improvement and development of partial weight generation methods, such as those disclosed in Non-Patent Literature 2 and found various problems. One of these problems relates to implementing a partial weight generation method on a virtualization or cloud platform. As previously mentioned, a virtualization or cloud platform enables the virtualization, encapsulation, or cloudification of RAN network functions, and allows virtualized RAN network function applications to offload computing tasks to HW accelerators. However, it is unclear which processes of a partial weight generation method are suitable for being offloaded to HW accelerators. In other words, it is unclear what information is appropriate for an application to provide to a virtualization or cloud platform for HW acceleration over an AAL interface. The inventors have studied implementations that offload the weight calculations of a partial weight generation method to an HW accelerator. As mentioned above, in Non-Patent Literature 6, the parameters sent from an application to an AAL or HW accelerator include an ordered list of UEs selected for scheduling, the number of scheduled layers per UE, and estimated channel information. However, these parameters may not be sufficient to offload the weight calculations of a partial weight generation method to an HW accelerator.

Note that implementations using HW accelerators can be used to configure RAN network components (e.g., DUs), regardless of RAN virtualization or open platforms. In other words, a RAN network component (e.g., DU) can be implemented without a virtualization platform capable of running multiple virtualized machines or containers. Specifically, a RAN network component (e.g., DU) can be implemented using hardware and software that provides a RAN network function application and a running environment in which the RAN network function application runs. Hardware may include computing, networking, and storage components, as well as HW accelerators. Software may include an operating system (OS) and device drivers. Even with this configuration, it is unclear which processing of a partial weight generation method is suitable for being offloaded to HW accelerators. In other words, it is unclear what information is appropriate for the application to provide to the OS or a device driver for HW acceleration.

One of the objectives to be achieved by the example embodiments disclosed herein is to provide apparatus, methods, and programs that provide an implementation suitable for offloading some of the processing of a partial weight generation method to an HW accelerator. It should be noted that this object is only one of the objects to be achieved by the example embodiments disclosed herein. Other objects or problems and novel features will become apparent from the following description and the accompanying drawings.

### Solution to Problem

In a first aspect, a computer system includes hardware including a memory storing one or more programs, at least one processor, and a hardware accelerator. When executed by the at least one processor, the one or more programs cause the computer system to provide an environment in which an application for providing radio access network functions runs. The environment is adapted to allow the application to offload a weight calculation processing to the hardware accelerator. The environment is adapted to receive from the application, in a request to offload the weight calculation processing, data and information required for the weight calculation processing to be processed by the hardware accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element.

In a second aspect, a method performed by a computer system includes: providing an environment in which an application for providing a radio access network function runs; and receiving from the application, in a request to offload a weight calculation processing, data and information required for the weight calculation processing to be processed by a hardware accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element.

A third aspect is directed to one or more programs containing instructions that, when executed by a computer system, cause the computer system to perform a method. The method includes providing an interface for offloading one or more processes to a hardware accelerator for an application that provides a virtualized radio access network function running on the computer system. The method also includes receiving from the application, in a request to offload a weight calculation processing, data and information required for the weight calculation processing to be processed by the hardware accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element.

In a fourth aspect, a method performed by a computer system includes providing an interface for offloading one or more processes to a hardware accelerator for an application that provides a virtualized radio access network function running on the computer system. The method also includes receiving from the application, in a request to offload a weight calculation processing, data and information required for the weight calculation processing to be processed by the hardware accelerator.

A fifth aspect is directed to one or more programs containing instructions that, when executed by a computer system, cause the computer system to perform a method. The method includes sending, in a request to offload a weight calculation processing, via an interface provided by the computer system, data and information required for the weight calculation processing to be processed by a hardware accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element.

In a sixth aspect, a method performed by a computer system includes sending, in a request to offload a weight calculation processing, via an interface provided by the computer system, data and information required for the weight calculation processing to be processed by a hardware accelerator. The data and information contain at least: (a) first information indicating a first subset of radio terminals to which a common interference cancellation matrix applies, selected from a set of radio terminals communicating with a radio access network element; and (b) second information indicating a subset of antennas serving the subset of the radio terminals, selected from a set of antennas coupled to the radio access network element.

### Advantageous Effects of Invention

According to the aspects described above, it is possible to provide apparatus, methods, and programs that provide an implementation suitable for offloading some of the processing of a partial weight generation method to an HW accelerator.

### BRIEF DESCRIPTION OF DRAWINGS

FIG. 1 shows an example configuration of a radio communication system related to one or more example embodiments.

FIG. 2 shows an example configuration of radio access network elements related to one or more example embodiments.

FIG. 3 shows an example implementation of radio access network elements related to one or more example embodiments.

FIG. 4 shows an example of HW acceleration related to one or more example embodiments.

FIG. 5 is a flowchart showing an example of the operation of a radio access network element related to one or more example embodiments.

FIG. 6 shows a specific example of HW acceleration related to one or more example embodiments.

FIG. 7 is a diagram illustrating an example of clustering of UEs in a partial weight generation method.

FIG. 8 is a diagram illustrating an example of clustering of target UEs in a partial weight generation method.

FIG. 9 is a diagram illustrating an example of clustering of antennas in a partial weight generation method.

FIG. 10 is a diagram illustrating an example of selecting UEs to be considered as interference sources in a partial weight generation method.

FIG. 11 shows an example of a partial channel matrix used in a partial weight generation method.

FIG. 12 shows an example of a partial channel matrix used in a partial weight generation method.

FIG. 13 is a diagram illustrating parameters used in a partial weight generation method.

FIG. 14 is a sequence diagram showing an example of signaling between an application and an AAL related to one or more example embodiments.

FIG. 15 is a flowchart showing an example of the operation of a radio access network element related to one or more example embodiments.

FIG. 16 shows an example configuration of a computer system related to one or more example embodiments.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

Each of the drawings or figures is merely an example to illustrate one or more example embodiments. Each figure may not be associated with only one particular example embodiment but may be associated with one or more other example embodiments. As will be appreciated by those of ordinary skill in the art, various features or steps described with respect to any one of the figures may be combined with features or steps illustrated in one or more other figures to produce, for example, example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The following example embodiments are described primarily with respect to the O-Cloud, which is in accordance with the O-RAN technical specifications. However, these example embodiments can also be applied to other systems that support technologies similar to the O-Cloud, such as virtualization platforms augmented with HW accelerators.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

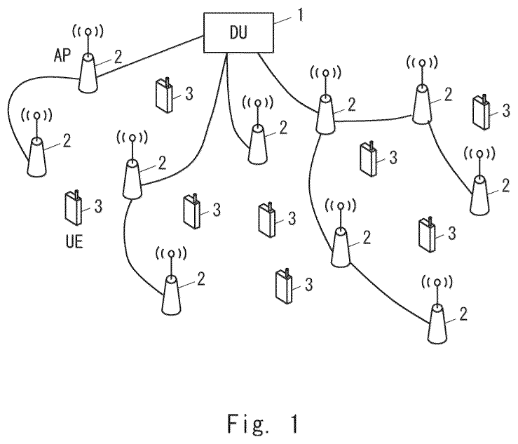

First, configurations and operations of a plurality of elements common to a plurality of example embodiments are described. FIG. 1 shows an example configuration of a radio communication system related to a plurality of example embodiments. Each element (network function) shown in FIG. 1 can be implemented, for example, as a network element on dedicated hardware, as a software instance running on dedicated hardware, or as a virtualized function instantiated on an application platform.

In the example shown in FIG. 1, a radio communication system includes a distributed unit (DU) 1, a plurality of APs 2, and a plurality of UEs 3. The radio communication system supports distributed MIMO. As previously mentioned, the fundamental concept of distributed MIMO is to use a relatively large number of APs 2, i.e., antennas, spread across a broad area to serve a relatively small number of UEs 3. Similar to existing centralized MIMO (or network MIMO), distributed MIMO enables multi-user MIMO (MU-MIMO) transmission, which communicates with multiple UEs 3 spatially multiplexed on the same time and frequency resources.

The DU 1 is a network element that performs digital baseband signal processing. The DU 1 is connected to multiple APs 2 via fronthaul connections. Each fronthaul link may be wired or wireless. The topology of the fronthaul links or the fronthaul network connecting the DU 1 to the multiple APs 2 is not limited and may be hub-and-spoke, tree, ring, or (partial) mesh, for example. The DU 1 may also be referred to as a baseband unit, digital unit, central processing unit (CPU), edge cloud processor, or by another term. The DU 1 digitally combines signals using precoding weights and postcoding weights during downlink transmission and uplink reception, respectively. Postcoding weights are sometimes referred to as combining weights, receiving combining weights, reception weights, or spatial filtering weights. As mentioned above, in this specification, the terms “precoding weights” and “postcoding weights” will be collectively referred to as “weights.” The DU 1 may use the partial weight generation method described above to calculate the weights.

The APs 2 are geographically distributed. Each of the distributed APs 2 is connected to the DU 1, which performs digital baseband signal processing, via a fronthaul connection. Each AP 2 is equipped with one or more antenna elements. Each AP 2 may have a fully digital configuration, in which each antenna element is connected to its own radio frequency (RF) circuit, or may have a subarray configuration, in which a subarray composed of multiple antenna elements shares a single RF circuit. In the case of a subarray configuration, each AP 2 may perform analog beamforming. Each AP 2 may be referred to as an antenna, transmission and reception point (TRP), radio unit (RU), remote radio head, or by another term.

Some or all of the UEs 3 perform spatial multiplexing transmission with distributed APs 2 on the same time and frequency resources. The transmission or reception layer of each UE 3 may be one or more. For simplicity, the following description mainly covers cases where a UE 3 has one transmission or reception layer, but those skilled in the art will understand that this can be extended to cases where a UE 3 has two or more transmission or reception layers. UEs 3 may be referred to as radio terminals, mobile terminals, mobile stations, wireless transmit receive units (WTRUs), or by another term.

In some implementations, the DU 1 may be connected to a Central Unit (CU), which is not shown in the figure. The CU may be connected to multiple DUs 2. In this case, the CU, one or more DUs 2, and the APs 2 connected to each DU 1 may correspond to one base station. In other words, one base station may include a CU, one or more DUs 2, and APs 2. A base station may be referred to as a radio access network node or a radio station. In Beyond 5G or 6G systems, a base station may be an enhanced gNB. In one example, the DU 1 hosts the Radio Link Control (RLC) layer and Medium Access Control (MAC) layers of an enhanced gNB and may host part or all of the Physical (PHY) layer of the enhanced gNB. If the DU 1 hosts part of the PHY layer, specifically the High PHY layer, the signal processing for the remaining PHY layer, i.e., the Low PHY layer, is implemented in the APs 2.

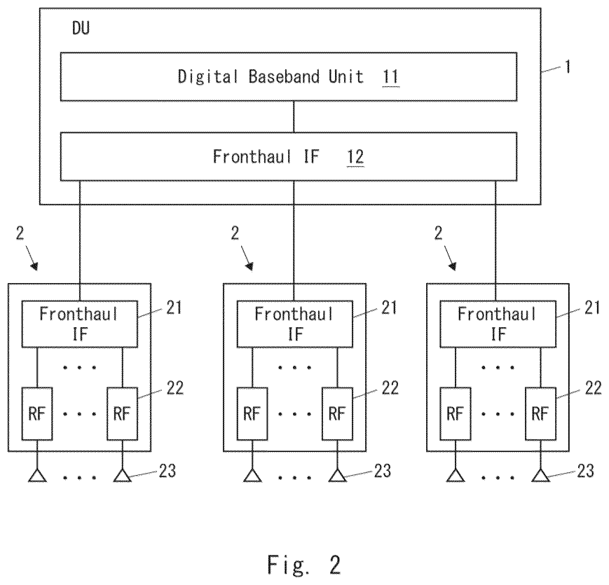

FIG. 2 shows an example configuration of the DU 1 and the APs 2. In the example of FIG. 2, the DU 1 includes a digital baseband unit 11. The digital baseband unit 11 performs weight calculation. The weight calculation may follow the partial weight generation method described above. The digital baseband unit 11 may also perform other high PHY layer signal processing tasks, such as encoding and decoding, modulation and demodulation, layer mapping, and resource element mapping. The digital baseband unit 11 may also perform other digital signal processing tasks, including some Layer 2 processing (e.g., RLC and MAC layers). A fronthaul interface 12 is connected to the APs 2 via fronthaul lines. The fronthaul lines may be based on, for example, Radio over Fiber (RoF) technology, Common Public Radio Interface (CPRI) technology, or Enhanced CPRI (eCPRI) technology.

In the example shown in FIG. 2, each AP 2 includes a fronthaul interface 21 and a plurality of RF circuits 22. The fronthaul interface 21 is connected to the fronthaul interface 12 of the DU 1 via a fronthaul line. Each RF circuit 22 includes an amplifier, a frequency converter, and other components, and transmits and receives RF signals. In the example shown in FIG. 2, a fully digital configuration is used in which each antenna element 23 is equipped with one RF circuit 22. The port on the baseband side of each RF circuit 22 is considered an equivalent antenna in the baseband domain and will be referred to as an antenna hereinafter.

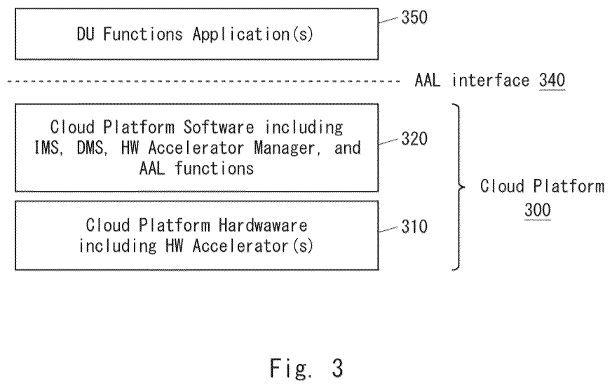

The DU 1 shown in FIGS. 1 and 2 may be implemented on a virtualization or cloud platform as virtualized, containerized, or cloudified network functions. FIG. 3 shows an example of the implementation of a virtualized DU 1. The functions of DU 2 are realized by cloud platform 300 and one or more DU function applications 350 running on the execution environment provided by the cloud platform 300. The cloud platform 300 includes cloud platform hardware 310 and software 320. The cloud platform hardware 310 includes computing, networking, and storage components, as well as one or more HW accelerators. The HW accelerators include, for example, FPGAs, GPUs, DSPs, ASICs, or any combination thereof.

The cloud platform software 320 provides APIs for managing the lifecycle of virtualized RAN network functions, including the DU function application(s) 350. The cloud platform software 320 may use virtual machines (VMs) orchestrated and managed with OpenStack, containers orchestrated and managed with Kubernetes, or both to implement virtualized (or containerized or cloudified) RAN network functions. The cloud platform software 320 enables RAN network function applications (e.g., the DU function application(s) 350) running on the platform 300 to offload computing tasks to one or more HW accelerators and provides an AAL interface 340 (i.e., APIs) for these applications to utilize HW accelerators. The cloud platform software 320 may include a host OS and device drivers. The host OS may be referred to as a kernel. In addition to or instead of the host OS, the cloud platform software 320 may include virtualization supporting software such as a hypervisor (e.g., OpenStack hypervisor, VMware (registered trademark) hypervisor) or a container engine (e.g., Docker (registered trademark) engine). The AAL interface 340 (i.e., APIs) may run in the kernel space or in the user space of the host OS.

The cloud platform 300 may be an O-Cloud conforming to the O-RAN technical specifications. In this case, the cloud platform software 320 may provide Deployment Management Services (DMS), Infrastructure Management Services (IMS), HW Accelerator Manager, and AAL functions. The cloud platform software 320 may include software, such as one or more programs, software libraries, and device drivers, that utilize and collaborate with the hardware 310 to provide these functions. Transport between RAN network function applications (e.g., the DU function application(s) 350) and the AAL can be based on various types (e.g., shared memory, Peripheral Component Interconnect Express (PCIe (registered trademark)) interconnect, or Ethernet (registered trademark)).

The APIs provided by the AAL interface 340 may include AALI-C-App and AALI-P that comply with the O-RAN technical specifications, or enhancements thereof. The AALI-C-App is a set of APIs provided by the AAL (i.e., the cloud platform software 320) to RAN network function applications (e.g., the DU function application(s) 350) for common operations, actions, and events. The AALI-C-App enables RAN network function applications to perform operations per AAL Logical Processing Unit (LPU), such as acquiring AAL-LPU information (e.g., types of available AAL profiles), creating an AAL profile instance on an AAL-LPU, configuring an AAL profile instance, starting an AAL profile instance, configuring an AAL queue on an AAL profile instance, and starting an AAL queue.

An AAL-LPU is a logical representation of resources within an instance of an HW accelerator. For example, an HW accelerator may have multiple processing units or subsystems, or may be partitioned into multiple resources, which can be logically represented as AAL-LPUs. An AAL-LPU is presented to an application using an AAL application interface (API). An AAL-LPU is mapped to a single HW accelerator. An AAL-LPU is uniquely identified within an HW accelerator. An HW accelerator supports one or more AAL-LPUs. Each AAL-LPU shares the resources of the associated HW accelerator with other AAL-LPUs mapped to that same HW accelerator. An AAL-LPU can support one or more AAL profiles. An AAL-LPU can execute zero to N AAL profile instances per supported AAL profile. An AAL-LPU can serve zero or more applications.

An AAL profile specifies a set of accelerated functions that are processed by HW accelerators on behalf of applications within O-RAN cloudified network functions. An AAL profile instance is an executable instance of an AAL profile that applications can use via the AAL interface. An AAL profile instance is executed within the execution environment of an AAL-LPU.

An AAL queue is part of the API (i.e., AALI-P) for a specific AAL profile, is used by applications to group operations, and is defined as an abstract structure that can access specific resources (computing, I/O) of an AAL-LPU that supports the specific AAL profile. From an application's perspective, each AAL-LPU that supports a specific AAL profile consists of one or more AAL queues. While an AAL-LPU can support multiple AAL profiles, an AAL queue supports only one type of AAL profile. An AAL queue optionally supports prioritization, which enables applications or network functions to schedule jobs with different priorities to an AAL-LPU. Applications or network functions (e.g., the DU function application(s) 350) can use multiple AAL queues to access different AAL profiles supported by an AAL-LPU.

The AALI-P is a set of AAL-profile-specific APIs that depend on each defined AAL profile. The AAL profiles currently defined by O-RAN WG6 include, along with other profiles, the AAL profile relating to MU-MIMO beamforming (precoding) weight calculation (i.e., AAL_MU-MIMO_PRECODER_WEIGHTS_CALC profile), as well as the AAL profiles relating to forward error correction (FEC) calculation for downlink and uplink physical channels (i.e., AAL_PDSCH_FEC profile and AAL_PUSCH_FEC profile). The AAL interface 340 may support these existing AAL profiles. The AAL interface 340 may support enhanced versions of existing profiles or other AAL profiles.

The DU 1 shown in FIGS. 1 and 2 may be implemented without using a virtualization platform capable of executing multiple virtual machines or containers. Specifically, the DU 1 may be implemented with RAN network function applications, as well as hardware and software that provide an execution environment in which the RAN network function applications run. The hardware may include computing, networking, and storage components, as well as HW accelerators. The software may include an OS and device drivers. The OS may be referred to as a kernel. In this implementation, the OS or another application may provide an AAL interface for RAN network function applications to use HW accelerators. The AAL interface (i.e., APIs) may operate in the kernel space or in the user space of the host OS.

### First Example Embodiment

This example embodiment provides implementation details for offloading some processing of a partial weight generation method to an HW accelerator. Example configurations of a radio communication system related to this example embodiment are similar to those described with reference to FIGS. 1 to 3.

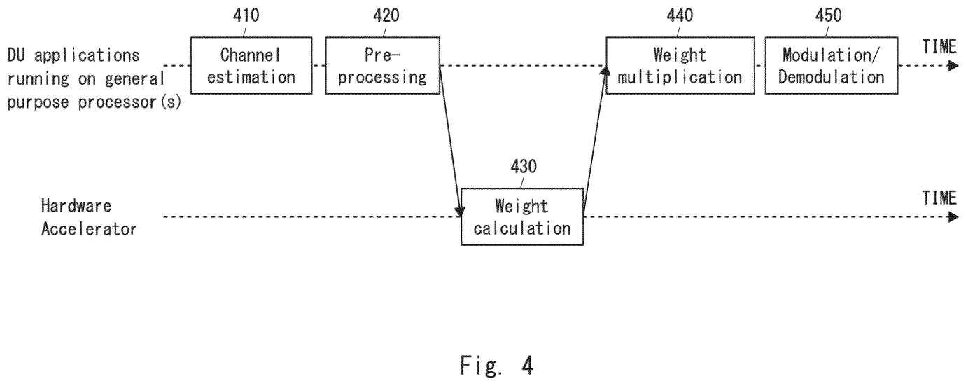

FIG. 4 shows an example of HW acceleration used by the DU function application(s) 350. In the example shown in FIG. 4, the DU function application(s) 350 is/are executed in an execution environment (e.g., a VM or a container) provided by the cloud platform 300, specifically on one or more general purpose processors (e.g., CPU(s)), and perform high PHY layer processing for distributed MIMO. The high PHY layer processing performed by the DU function application(s) 350 includes channel estimation processing 410, pre-processing for weight calculation 420, weight multiplication processing 440, and modulation or demodulation processing 450. Meanwhile, the DU function application(s) 350 offload(s) weight calculation processing 430 to an HW accelerator. In the example shown in FIG. 4, the HW accelerator is of the look aside type, and it passes its processing result to the DU function application(s) 350. The DU function application(s) 350 receive(s) the result of the weight calculation from the HW accelerator and use it to perform the weight multiplication processing 440. Some of the processing performed by the DU function application(s) 350 and the general-purpose processor(s) shown in FIG. 4 may be offloaded to other HW accelerators. For example, the modulation or demodulation processing 450 may be offloaded to another HW accelerator. Additionally or alternatively, the weight multiplication processing 440 may be offloaded to another HW accelerator. In this case, the HW accelerator performing the weight calculation processing 430 may be an inline accelerator that sends the calculated weight data to the HW accelerator performing the subsequent weight multiplication processing 440.

The pre-processing for weight calculation 420 provides a subsystem selection for a partial weight generation method. As described in the Background Art section, the partial weight generation method involves the DU 1 selecting a first subset (or cluster) of UEs from the multiple UEs 3 communicating with the DU 1 and selecting a subset (or cluster) of antennas serving the first subset of UEs from the multiple antennas of the multiple APs 2. Additionally, the DU 1 may select a second subset of UEs (interfering UEs) to be considered as interference sources in the weight calculation per subsystem. Thus, a subsystem includes a first subset of UEs, a subset of selected antennas serving the first subset of UEs, and, optionally, a second subset of UEs corresponding to interfering UEs. The precoding or postcoding weights of the first subset of UEs in one subsystem can be calculated using a common interference cancellation matrix. In other words, the first subset of UEs in a subsystem is subject to the same interference cancellation matrix. An interference cancellation matrix refers to the inverse matrix part in the calculation formula for ZF weights or MMSE weights. The weight calculation processing 430 to be offloaded to the HW accelerator includes inverse matrix calculation for obtaining the interference cancellation matrix.

After the pre-processing 420, the DU function application(s) 350 send(s) data and information required for the weight calculation processing 430 to be processed by the HW accelerator, via the AAL interface 340 provided by the cloud platform 300. In other words, the DU function application(s) 350 send(s) a request to the cloud platform 300 to offload the weight calculation processing 430. The DU function application(s) 350 may provide the data and information to the platform 300 (specifically, the AAL) using an API specific to an AAL profile, such as the AALI-P of O-Cloud. The data and information at least contain first information indicating the first subset of UEs and second information indicating the subset of antennas serving the first subset of UEs. The data and information also contain information on the estimated channel matrix calculated by the channel estimation processing 410. The data and information may also contain third information indicating the second subset of UEs corresponding to interfering UEs. The first information may include the identifiers (IDs) of UEs in the first subset, i.e., target UEs for the weight calculation. The second information may include the IDs of selected antennas. The third information may include the IDs of the UEs in the second subset, i.e., interfering UEs. If each UE 3 is equipped with multiple antennas and has two or more communication layers, the first information may specify a set of UE layer IDs to identify the multiple layers of the UEs. Similarly, the third information may specify a set of UE layer IDs to identify the multiple layers of the interfering UEs.

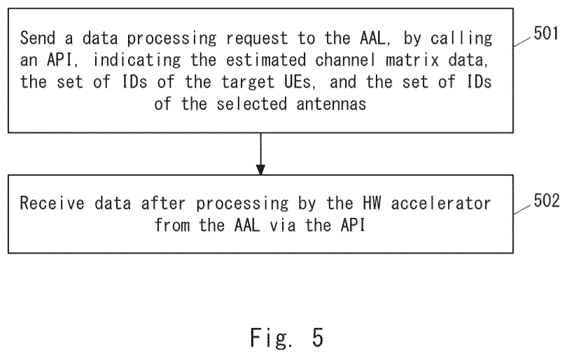

FIG. 5 shows an example of the processing provided by the DU function application(s) 350. When the DU function application(s) 350 is/are executed in an execution environment (e.g., a VM or a container) provided by the cloud platform 300, the DU function application(s) 350 cause(s) the cloud platform 300 to perform the processing shown in FIG. 5. In step 501, the DU function application(s) 350 send(s) a data processing request indicating the estimated channel matrix data, the set of IDs of the target UEs, and the set of IDs of the selected antennas to the AAL by calling an API. The request is a request to offload the weight calculation processing. The data processing request may optionally include the set of IDs of the interfering UEs. In step 502, the DU function application(s) 350 receive(s) the (post-processed) data after processing by the HW accelerator from the AAL via the API. If inline acceleration is used, step 502 may be omitted. Alternatively, in step 502, the DU function application(s) 350 may receive the processing results from an HW accelerator performing subsequent processing (e.g., weight multiplication, modulation, or demodulation).

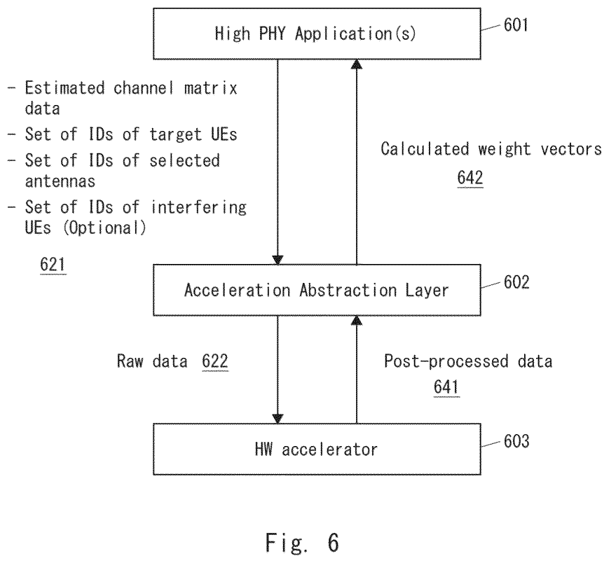

FIG. 6 shows an example of data and information flow for offloading a weight calculation per subsystem in the partial weight generation method to an HW accelerator. The high PHY function application(s) 601 correspond(s) to at least a part of the DU function application(s) 350 described above. An Acceleration Abstraction Layer (AAL) 602 is provided by the cloud platform described above. The high PHY function application(s) 601 send(s) data and information 621 to the AAL 602 via an API. The data and information 621 contains estimated channel matrix data, IDs of target UEs, and IDs of selected antennas. Optionally, it may also contain IDs of interfering UEs. The AAL 602 sends raw data 622 (i.e., the data and information received from the high PHY function application(s) 601) to an HW accelerator 603. Before sending the data and information received from the high PHY function application(s) 601 to the HW accelerator 603, the AAL 602 may process it. For example, the AAL 602 may select data of one or more partial channel matrices necessary for weight calculation of the subsystem from the received channel matrix data and send the selected data of the partial channel matrices to the HW accelerator 603. Additionally or alternatively, the AAL 602 may generate diagonal matrix data indicating the subset of antennas and send it to the HW accelerator 603. The AAL 602 receives or acquires post-processed data 641 from the HW accelerator. The high PHY function application(s) 601 receive(s) or acquire(s) calculated weight vectors 642 from the AAL 602.

The above explanation referring to FIGS. 4 to 6 mainly targets the implementation shown in FIG. 3, in which the RAN network functions of the DU 1 operate on a cloud platform. However, the operation of the applications and platform (or AAL) for offloading weight calculations to the HW accelerator, as described with reference to FIGS. 4 to 6, can also be applied to a DU 1 that is not implemented on a virtualization platform capable of executing multiple virtual machines or containers.

As understood from the above description, in the example embodiment, the DU function application(s) (e.g., DU function application(s) 350, 601) executed on a general-purpose processor perform(s) pre-processing for weight calculation, i.e., selection or determination of a subsystem, while the HW accelerator (e.g., HW accelerator 603) performs weight calculation, including inverse matrix calculation. This distribution of functions provides the following advantages. The clustering of UEs and antennas performed during the preprocessing stage can utilize various clustering algorithms (e.g., K-means, K-medoids). Additionally, various constraints can be imposed on the clustering process. Furthermore, there are various variations in the metrics considered in the clustering process. Having the DU function application(s) perform the pre-processing allows for low-cost, flexible changes or updates to the subsystem determination algorithm. Conversely, the weight calculation processing includes inverse matrix calculations, which require a significant computational load. Having the HW accelerator perform the weight calculation processing contributes to the performance optimization of the partial weight generation method.

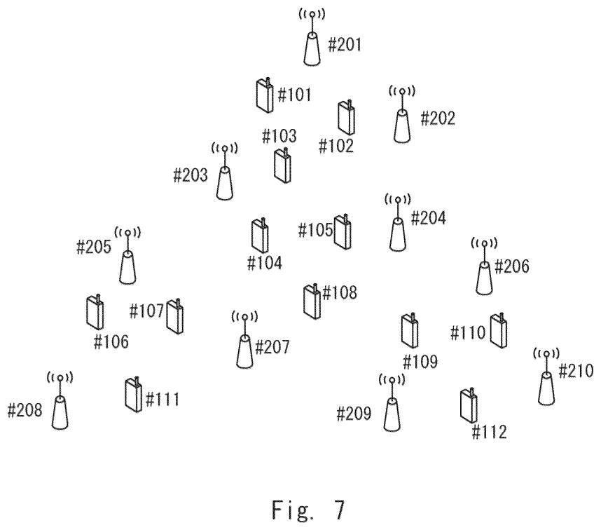

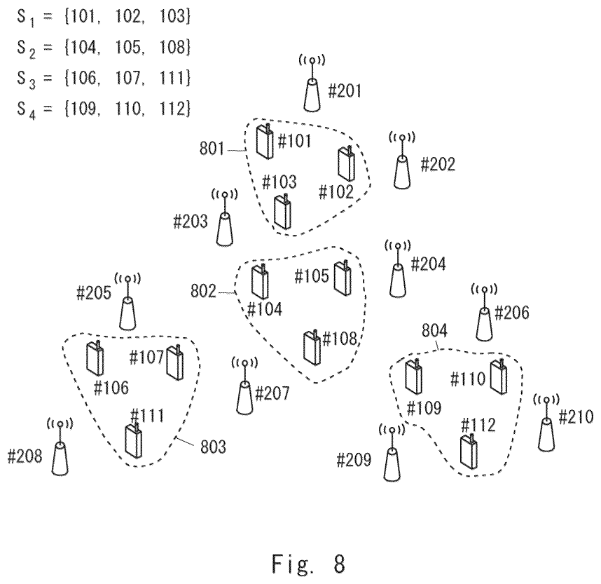

The following is an example of how to determine subsystems using the partial weight generation method. FIG. 7 shows the state before selecting subsystems. In the example in FIG. 7, there are 12 UEs and 10 antennas. Here, it is assumed that each UE has one transmission layer. Accordingly, the 12 UEs are identified by UE layer IDs #101 to #112. The ten antennas are identified by antenna IDs #201 to #210. FIG. 8 shows the selection of the first subset. In the example shown in FIG. 8, the 12 UEs are clustered into four subsets 801 to 803, with three UEs in each subset. The subset 801 or subset S₁ includes UE layers having IDs #101, #102, and #103. The subset 802 or subset S₂ includes UE layers having IDs #104, #105, and #108. The subset 803 or subset S₃ includes UE layers with IDs #106, #107, and #111. The subset 804 or subset S₄ includes UE layers with IDs #109, #110, and #112. The clustering of the UE layer into these four subsets may be performed using the K-means method or the K-medoids method. More specifically, the clustering can be performed using the K-means method based on the location information of the UEs, with the constraint that the number of UEs in one subset (or cluster) is limited. The following explanation focuses on the subset 802 or subset S₂.

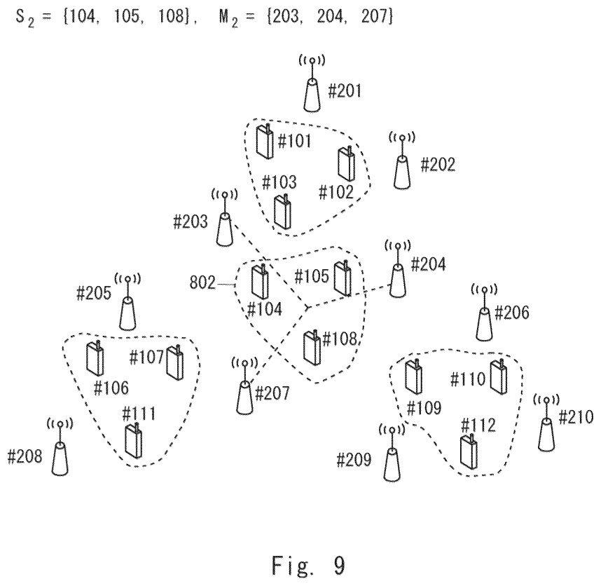

FIG. 9 selects a subset M₂ of antennas that serve the three UE layers in the subset 802 or subset S₂. In the example shown in FIG. 9, three antennas #203, #204, and #207 are selected for the subset 802 or subset S₂. Selection of antennas may be performed according to the maximum channel gain criterion. Specifically, one or more antennas with the largest channel gain may be selected for each UE layer within the subset, and the final number of antennas may be determined while considering antenna overlap between the UE layers, provided that the number does not exceed a predetermined maximum.

FIG. 9 shows the selection of the second subset (i.e., the set of interfering UE layers that are considered as interference sources during the weight calculation per subsystem). In the example shown in FIG. 9, three UE layers #103, #107, and #109 are selected as subset T₂ of UE layers that are considered as interference sources for the communications of the subset 802 or subset S₂. The selection of the interfering UE layers may be performed based on the maximum channel gain criterion. Specifically, one or more UE layers with a large channel gain to the selected antenna may be chosen from UE layers outside the subset 802 or subset S₂. Hereinafter, union 1001 of the first subset (subset M₂) and the second subset (subset T₂) is referred to as subset P₂.

The downlink partial MMSE weight vector W₁₀₄^{P} of UE layer #104 in subset S₂ is expressed by the following equation:

$${W}_{104}^{P} = {( {\sum }_{v ∈ {p}_{2}} {p}_{v} {D}_{2} {h}_{v} {h}_{v}^{H} {D}_{2} + {σ}^{2} {D}_{2} )}^{- 1} {D}_{2} {h}_{104} = {R}_{2}^{- 1} {D}_{2} {h}_{104} \qquad ( 1 )$$

where pᵥ is the transmit power to UE layer #v, hᵥ is the uplink channel vector of UE layer #v, and σ² is the noise power. D₂ is a 10×10 diagonal matrix diag (d₂₀₁, . . . , dₐ, . . . d₂₁₀) indicating the antennas included in subset M₂, and its diagonal elements are defined by the following equation:

$${d}_{a} = \{ \begin{matrix}1 & if a ∈ {M}_{2} \\ 0 & if a ∉ {M}_{2}\end{matrix} \qquad ( 2 )$$

The downlink partial MMSE weight vectors W₁₀₅^{P} and W₁₀₈^{P} of the remaining UE layers #105 and #108 in subset S₂ are expressed by the following equations, each of which includes an interference cancellation matrix R₂⁻¹ (i.e., inverse matrix part on the right-hand side) that is the same as the downlink partial MMSE weight vector W₁₀₄^{P} of UE layer #104:

$${W}_{105}^{P} = {R}_{2}^{- 1} {D}_{2} {h}_{105} \qquad ( 3 )$$

$${W}_{108}^{P} = {R}_{2}^{- 1} {D}_{2} {h}_{108} \qquad ( 4 )$$

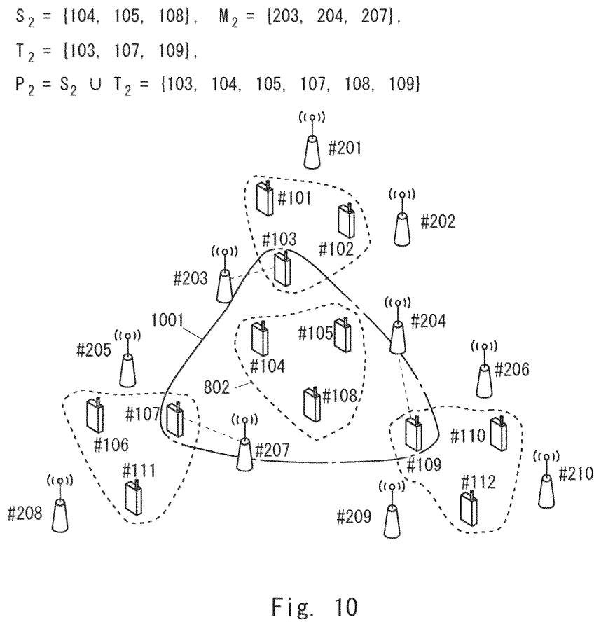

The downlink partial MMSE weight vectors shown in equations (1) to (4) can be rewritten as follows:

$${W}_{k}^{P} = {( {H}_{k}^{P} {H}_{k}^{{P}^{H}} + {σ}^{2} {I}_{\vert {M}_{k} \vert} )}^{- 1} {H}_{k}^{S} \qquad ( 5 )$$

where Wₖ^{P} is a weight matrix that summarizes the weight vectors of the UE layers in subset Sₖ. Hₖ^{S} is a partial channel matrix determined based on the target UE layer subset Sₖ and the antenna subset Mₖ. Meanwhile, Hₖ^{P} is a partial channel matrix determined based on the union Pₖ of the target UE layers and the interfering UE layers and the antenna subset Mₖ. Considering the target UE layer subset S₂ in the example shown in FIG. 10, the downlink partial MMSE weight matrix is expressed by the following equation:

$${W}_{2}^{P} = [ \begin{matrix}{w}_{104}^{P} & {w}_{105}^{P} & {w}_{108}^{P}\end{matrix} ] = {( {H}_{2}^{P} {H}_{2}^{{P}^{H}} + {σ}^{2} {I}_{3} )}^{- 1} {H}_{2}^{S} \qquad ( 6 )$$

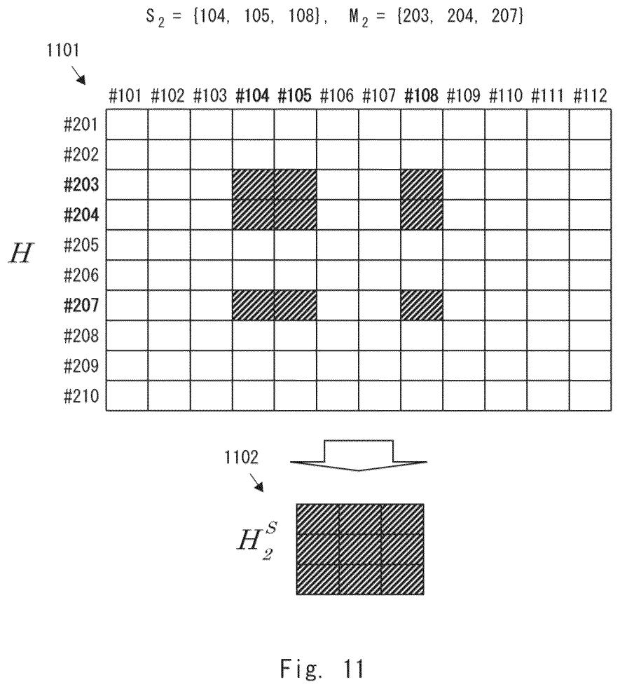

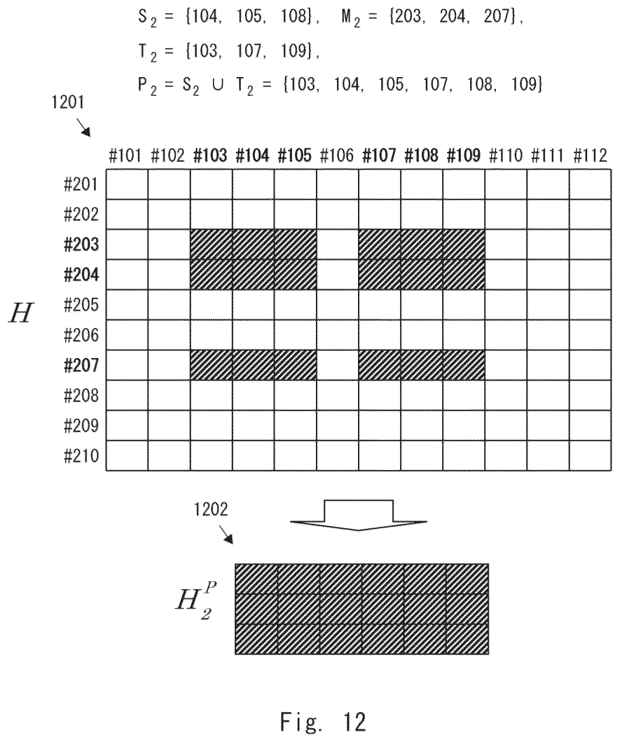

As shown in FIG. 11, the partial channel matrix H₂^{S} is a three-row, three-column matrix (1102) consisting of nine elements selected from the overall channel matrix (1101). Meanwhile, as shown in FIG. 12, the partial channel matrix H₂^{P} is a 3-row, 6-column matrix (1202) consisting of 18 elements selected from the overall channel matrix (1201).

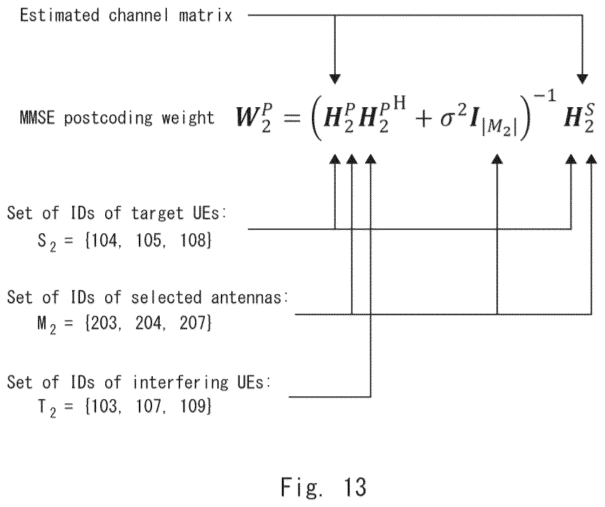

FIG. 13 schematically shows how the data and information passed from the application 601 to the AAL 602 in FIG. 6 are used to calculate the weight matrix according to equation (6). Specifically, in order to select the partial channel matrix H₂^{S} from the estimated channel matrix, information indicating the target UE layer subset S₂ and antenna subset M₂ is required. Meanwhile, in order to select the partial channel matrix H₂^{P} from the estimated channel matrix, information indicating the interfering UE layer subset T₂ is additionally required. The information indicating the antenna subset M₂ is also taken into account for generating the unit matrix. If the information indicating the interfering UE layer subset T₂ is not provided from the application 601 to the AAL 602, the AAL 602 and the HW accelerator 603 may treat all UE layers spatially multiplexed in the system as elements of the union set P₂. Alternatively, the AAL 602 and the HW accelerator 603 may treat only the first subset S₂ as elements of the union set P₂.

### Second Example Embodiment

This example embodiment provides a modification or improvement of the partial weight generation method described in the first example embodiment. Example configurations of a radio communication system related to this example embodiment are similar to those described with reference to FIGS. 1 to 3.

In this example embodiment, the AAL (e.g., the cloud platform software 320, the AAL 602) notifies an application (e.g., the DU function application 350, the high PHY function application 601) of the processing capacity of an HW accelerator or a logic processing unit (e.g., the AAL-LPU) associated with the HW accelerator that is available for weight calculation processing, via the AAL interface (e.g., the AAL-LPU interface 352). The AAL may send the notification in response to a request from the application. The notification may be performed during a configuration operation for the application to use the HW accelerator.

The processing capacity of an HW accelerator or logic processing unit (e.g., AAL-LPU) may include the number of weight generation profiles (e.g., AAL profiles) that can be executed in parallel by multiple logic processing units, as well as the matrix computing power of each weight generation profile. The matrix computing power of each weight generation profile may include the maximum size of a computable interference cancellation matrix for each weight generation profile. Additionally or alternatively, the matrix computing power of each weight generation profile may include the maximum number of UE layers that can be considered during the calculation of an interference cancellation matrix.

Additionally or alternatively, the processing capacity may include the maximum number of profile instances (e.g., AAL profile instances) that can be created in parallel for weight generation profiles within a single logic processing unit, as well as the matrix computing power for each profile instance (e.g., the maximum size of the interference cancellation matrix that can be calculated, the maximum number of UE layers that can be considered during the calculation of an interference cancellation matrix).

Additionally or alternatively, the processing capacity may include the number of AAL queues that can be created in parallel for weight generation profiles within a single logic processing unit, as well as the matrix computing power per offloaded calculation process (e.g., the maximum size of the interference cancellation matrix that can be calculated, the maximum number of UE layers that can be considered during the calculation of an interference cancellation matrix).

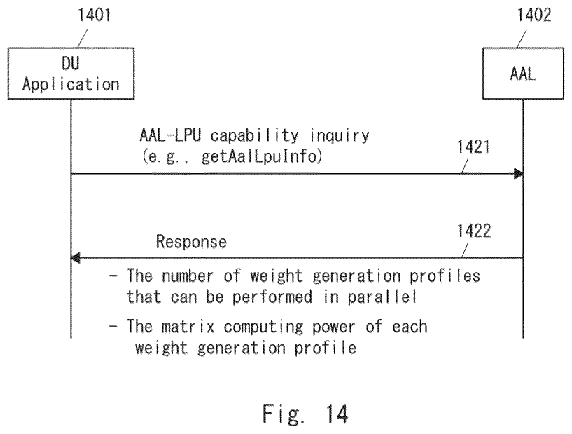

FIG. 14 shows an example of the operation of the AAL and the DU function application. In step 1421, the DU function application 1401 sends an AAL-LPU capability inquiry to the AAL 1402. The DU function application 1401 may activate a getAalLpuInfo operation in the AALI-C-App to send the AAL-LPU capability inquiry. In step 1422, the AAL 1402 sends a response to the query from the DU function application 1401. The response may be a getAalLpuInfo response. The response indicates the number of weight generation AAL profiles that can be performed in parallel in multiple AAL-LPUs, as well as the matrix computing power (e.g., the maximum size of a computable interference cancellation matrix) of each weight generation AAL profile. Additionally or alternatively, the response may indicate the number of AAL profile instances that can be created in parallel for weight generation AAL profiles within a single AAL-LPU, as well as the matrix computing power per profile instance. Additionally or alternatively, the response may indicate the number of AAL queues that can be created in parallel for weight generation profiles within a single logic processing unit, as well as the matrix computing power per single calculation process to be offloaded.

The application may determine the first subset of UE layers (or UEs) (i.e., the target UE layers (or UEs) for partial weight generation) based on or taking into account the processing capacity notification from the AAL. Specifically, the application may set the maximum number of UE layers that can be included in the first subset to the maximum size of a computable interference cancellation matrix in the AAL-LPU (or AAL profile instance). In some cases, the maximum size of a computable interference cancellation matrix may differ between multiple AAL-LPUs (or AAL profile instances). In this case, the application may set the upper limit of the number of UE layers to be included in each of the multiple first subsets Sₖ of the multiple subsystems to the maximum size of a computable interference cancellation matrix of the corresponding AAL-LPU (or AAL profile instance) to which the calculation process for that subsystem or subset is offloaded.

Additionally or alternatively, the application may determine the antenna subset based on or taking into account the processing capacity notification from the AAL. Specifically, the application may set the maximum number of antennas that can be included in the antenna subset to the maximum size of a computable interference cancellation matrix of the AAL-LPU (or AAL profile instance). As mentioned above, in some cases, the maximum size of a computable interference cancellation matrix may differ between multiple AAL-LPUs (or AAL profile instances). In this case, the application may set the maximum number of antennas to be included in each of the multiple antenna subsets Mₖ of the multiple subsystems to the maximum size of a computable interference cancellation matrix of the corresponding AAL-LPU (or AAL profile instance) to which the calculation process for that subsystem or subset is offloaded.

The application may determine the second subset of UE layers (or UEs), i.e., the interfering UE layers (or UEs), based on or taking into account the processing capacity notification from the AAL. Specifically, the application may set the upper limit of the size of the union of the first and second subsets to the maximum number of UE layers that can be taken into account during the calculation of an interference cancellation matrix. As mentioned above, in some cases, the maximum number of UE layers that can be taken into account during the calculation of an interference cancellation matrix may differ between multiple AAL-LPUs (or AAL profile instances). In this case, the application may set the upper limit of each of the multiple unions Pₖ of multiple subsystems to the maximum number of UE layers that can be considered in the corresponding AAL-LPU (or AAL profile instance) to which the calculation process for that subsystem is offloaded.

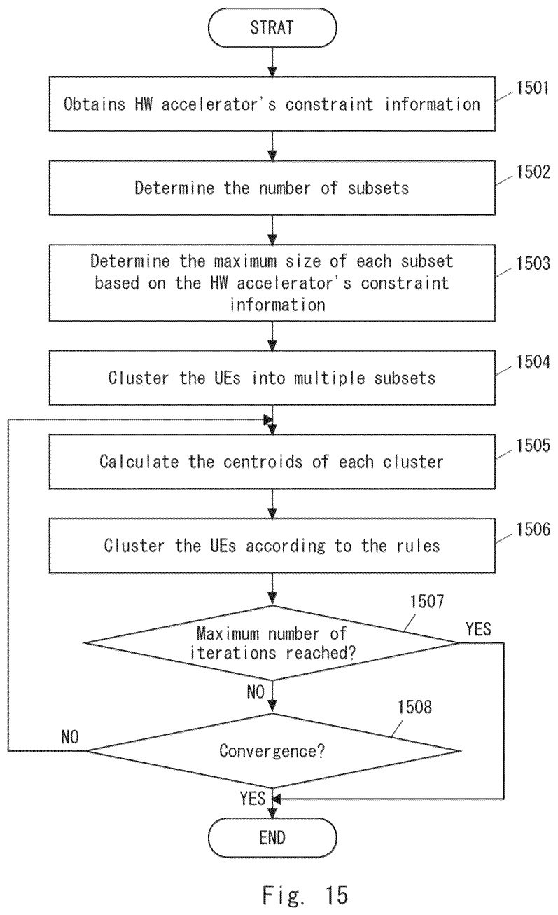

FIG. 15 shows an example of selecting the first subset considering the processing capacity of the HW accelerator or logic processing unit. In step 1501, the application obtains constraint information of the HW accelerator (or logic processing unit). The constraint information indicates the processing capacity of the HW accelerator or logic processing unit. Steps 1502 to 1508 correspond to clustering for selecting the first subset in the pre-processing for weight calculation (e.g., the pre-processing 420 in FIG. 4). In step 1502, the application determines the number of first subsets (or clusters), i.e., the number of subsystems. The application may set the number of first subsets (or clusters), i.e., the number of subsystems K, to the number Nₚₐᵣ of weight generation AAL profiles that can be executed in parallel received from the AAL.

In step 1503, the application determines the maximum number of UEs that can be included in each cluster (or subset) based on the processing capacity of the HW accelerator or logic processing unit. More specifically, the application sets the respective upper limits of the number of UEs in K clusters to the sizes C₁ to Cₖ of the maximum interference cancellation matrix that can be calculated by the HW accelerator or logic processing unit.

In step 1504, the application performs the initial clustering. More specifically, the application randomly selects the same number of UEs as the number of clusters K, determines the randomly selected UEs as provisional centroids, and clusters all UEs. In step 1505, the application calculates the centroids of each cluster.

In step 1506, the application (re) clusters the UEs according to the rules. The rules include the following. The application updates K centroid points according to the update rules of the K-means method in each iteration. The application assigns indexes from 1 to K to the K updated centroids, in descending order according to the number of UEs for which each centroid is the closest. The application sets un upper limit on the number of UEs that can be clustered into each of the K indexed centroids, from C₁ to Cₖ. If there are any UE(s) that cannot be clustered in the most appropriate centroid because of exceeding the limit, the application will place them in a cluster of another centroid instead. For example, if the number of UEs whose nearest centroid is centroid #k is Cₖ+3, the application selects three from the UEs whose nearest centroid is centroid #k in order of distance from the centroid. The application then places each of the three UEs into a cluster with the centroid that is the closest to that UE and has not exceeded the UE count limit. The application repeats clustering (steps 1505 and 1506) until a predetermined maximum number of iterations is reached (step 1507) or convergence is determined (step 1508).

### Third Example Embodiment

This example embodiment provides an improvement to the partial weight generation method. The improvements to the partial weight generation method described in this embodiment may be used in combination with the implementation of weight calculation using HW acceleration described in the first or second example embodiment. Example configurations of a radio communication system related to this example embodiment are similar to those described with reference to FIGS. 1 to 3.

The DU 1 performs a partial weight generation method. In the partial weight generation method, the DU 1 selects a first subset (or cluster) from the multiple UEs 3 communicating with the DU 1. The UEs in the first subset are the target UEs for weight calculation. Additionally, the DU 1 selects a subset (or cluster) of antennas from the plurality of antennas of the plurality of APs 2 to serve the first subset of UEs.

The clustering of UEs into multiple first subsets can be based on the K-means or K-medoids method. More specifically, the clustering can be performed using the K-means method based on the location information of the UEs, with the constraint that the number of UEs in one subset (or cluster) is limited. However, clustering based on the distance (physical or geographic distance) between UEs may not be sufficient. Specifically, UEs that are close to each other in distance may not necessarily be more susceptible to interference from each other, which may result in poor per-subsystem detection or synthesis performance.

To address this issue, in this example embodiment, the DU 1 clusters multiple UEs based on the channel power between each UE and each antenna. This allows UEs that have high interference with each other in the actual propagation environment to be clustered into the same subset and weights for these UEs to be generated simultaneously. This helps improve communication performance compared to clustering based on UE distance, which may not reflect the propagation environment accurately. Additionally, this has the advantage of not requiring the acquisition of the UEs' position information.

As an example, the DU 1 may cluster the UEs based on the spatial correlation of each UE's channel calculated from the channel power between each UE and all antennas. The DU 1 obtains the channel power between each UE and each antenna. The channel power may be the square value of the channel coefficient estimated from a Sounding Reference Signal (SRS) or a Demodulation Reference Signal (DMRS), for example. Alternatively, the channel power may be the received power (e.g., Reference Signal Received Power (RSRP)) of a downlink reference signal reported by the UE. The DU 1 calculates the spatial correlation between the two UEs #k and #k′ by the following equation:

$${r}_{k , {k}^{′}} = \frac{{p}_{k} \cdot {p}_{{k}^{′}}}{‖ {p}_{k} ‖ ‖ {p}_{{k}^{′}} ‖} \qquad ( 7 )$$

where pₖ is the channel power vector of UE #k and pr′ is the channel power vector of UE #k′. The numerator of equation (7) is the scalar product of the channel power vector pₖ and the channel power vector pₖ. The channel power vector pₖ has multiple elements, each representing the channel power between UE #k and each one of the multiple antennas of the base station. Similarly, the channel power vector pₖ′ has a plurality of elements, each representing the channel power between UE #k′ and each one of the plurality of antennas of the base station.

The DU 1 calculates spatial correlations for all pairs of UEs and clusters the UEs based on the obtained spatial correlations. Clustering can be done using any method, e.g., K-means or K-medoids method. DU 1 may use spatial correlation as a distance metric or instead of a distance metric for clustering. For example, the DU 1 may use the K-medoids method described in Non-Patent Literature 8.

### Fourth Example Embodiment

This example embodiment provides an improvement to the partial weight generation method. The improvements to the partial weight generation method described in this embodiment may be used in combination with the implementation of weight calculation using HW acceleration described in the first or second example embodiment. Example configurations of a radio communication system related to this example embodiment are similar to those described with reference to FIGS. 1 to 3.

The DU 1 performs a partial weight generation method. In the partial weight generation method, the DU 1 selects a first subset (or cluster) from the multiple UEs 3 communicating with the DU 1. The UEs in the first subset are the target UEs for weight calculation. Additionally, the DU 1 selects a subset (or cluster) of antennas from the plurality of antennas of the plurality of APs 2 to serve the first subset of UEs.

Selection of antenna subsets can be done by a maximum channel gain criterion. Specifically, one or more antennas with high channel gain may be selected for each UE in the subset, and no more than a predetermined maximum number of antennas may be finally determined, taking into account antenna overlap among UEs. However, even if antennas with high received power for UEs in the first subset are selected, they may receive significant inter-subsystem interference from UEs in another subsystem. In this case, the detection or synthesis performance per subsystem may be degraded.

To address this issue, in this example embodiment, the DU 1 selects an antenna subset by considering a Signal to Interference Ratio (SIR). Specifically, the DU 1 calculates the SIR with the channel power of the UEs in the first subset as the desired signal component and the channel power of the UEs not in the first subset as the interference component, or receives the calculated SIR. The DU 1 then selects one or more antennas to be included in the subset of antennas in descending order of the calculated SIR. This allows the DU 1 to avoid selecting antennas for the first subset that have high received power from the UEs in the first subset but at the same time have high inter-subset interference from other UEs.

For example, focusing on a certain UE subset u, the DU 1 calculates the SIR (SIR_{u,n}) at antenna #n for the subset u by the following equation:

$${SIR}_{u , n} = \frac{{\sum }_{k ∈ u} {P}_{k , n}}{{\sum }_{k ∉ u} {P}_{k , n}} \qquad ( 8 )$$

where the denominator is the sum of channel power between UEs not belonging to the subset u and antenna #n, and the numerator is the sum of channel power between UEs belonging to the subset u and antenna #n. The DU 1 calculates the SIR across all UE subsets and all antennas. The DU 1 then selects a specified number of antennas for each subset or subsystem in descending order of SIR.

### Fifth Example Embodiment

In the above example embodiments, the DU 1 (e.g., the DU functional application) may dynamically determine whether to perform offloading of the weight calculation processing to an HW accelerator. For example, the DU 1 may make this decision based on the number of UEs to be space-multiplexed. Specifically, the DU 1 may offload the weight calculation processing to an HW accelerator if the number of UEs to be space-multiplexed exceeds a threshold. Otherwise, the DU 1 may perform the weight calculation processing with an application (i.e., with a general-purpose processor).

In another example, the DU 1 may dynamically determine whether to offload the weight calculation processing to an HW accelerator, taking into account the processing performance of the available HW accelerators. Specifically, the DU 1 may refer to the number of weight generation profiles that can be performed in parallel in an HW accelerator (or associated logic processing unit), or the matrix computing power of in an HW accelerator (or associated logic processing unit), or both, to determine whether to offload the weight calculation processing.

In yet another example, the DU 1 may dynamically determine whether to offload the weight calculation processing to an HW accelerator, taking into account the number of APs in operation. Specifically, the DU 1 may offload the weight calculation processing to an HW accelerator if the number of APs in operation exceeds a threshold. Otherwise, the DU 1 may perform the weight calculation processing with an application (i.e., with a general-purpose processor).

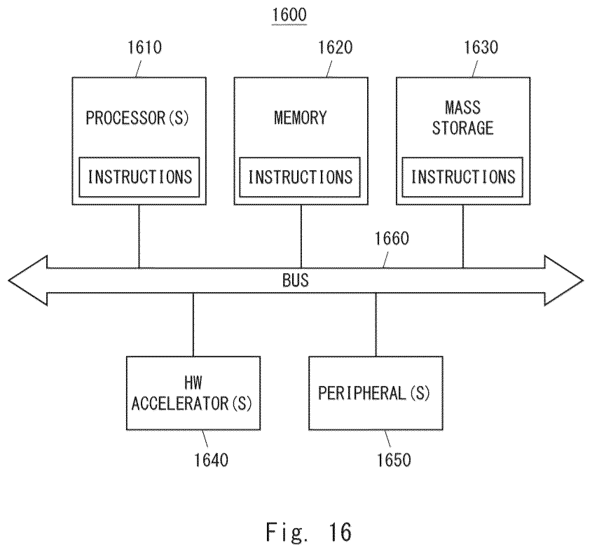

The following describes an example configuration of the cloud platform 300 related to the plurality of example embodiments described above. FIG. 16 is a block diagram showing an example configuration of the cloud platform 300.

In the example in FIG. 16, the cloud platform 300 is implemented as a computer system. The computer system includes one or more processors 1610, memory 1620, and mass storage 1630, which communicate with each other via bus 1660. For example, the one or more processors 1610 may include one or more central processing units (CPUs). The computer system includes one or more HW accelerators 1640, which may include, for example, FPGAs, GPUs, DSPs, or ASICs, or any combination thereof. The computer system may include other devices such as one or more peripherals 1650. The one or more peripherals 1650 may include a modem, or a network adapter, or any combination thereof.

One or both of the memory 1620 and the mass storage 1630 include a computer-readable medium storing one or more sets of instructions. These instructions may be partially or completely stored in memory within the one or more processors 1610. These instructions, when executed in the one or more processors 1610, cause the computer system to provide the functions of the cloud platform 300 described in the above example embodiments. These instructions, when executed in the one or more processors 1610, further cause the computer system to provide the functions of the DU function application described in the above example embodiments.

As explained using FIG. 16, one or more processors in a computer system can execute one or more programs containing a set of instructions to cause the computer to perform the algorithm described in the above example embodiments. The program(s) contains a set of instructions (or software codes) that, when loaded into a computer, causes the computer to perform one or more of the functions described in the example embodiments. The program(s) may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. The program(s) may be transmitted on a transitory computer readable medium or a communication medium. By way of example, and not limitation, transitory computer readable media or communication media can include electrical, optical, acoustical, or other form of propagated signals.

The above example embodiments are merely examples of the application of the technical concepts obtained by the inventors. These technical concepts are not limited to the above example embodiments and may be modified in various ways.

For example, the whole or part of the example embodiments disclosed above can be described as, but not limited to, the following supplementary notes. Some or all of the elements (e.g., configurations and functionality) described in Supplementary Notes directed to an apparatus (e.g., a computer system) may also be described in Supplementary Notes directed to a method or a program. Some or all of the elements (e.g., configurations and functionality) described in Supplementary Notes directed to a method may also be described in Supplementary Notes directed to an apparatus or a program. Alternatively, some or all of the elements (e.g., configurations and functionality) described in Supplementary Notes directed to a program may also be described in Supplementary Notes directed to an apparatus or a method. For example, some or all of the elements listed in Supplementary Notes 2-10 that depend on Supplementary Note 1 may also be listed as Supplementary Notes that depend on Supplementary Note 11 with the same dependency as Supplementary Notes 2-10. Similarly, some or all of the elements listed in Supplementary Notes 13-21 that depend on Supplementary Note 12 may also be listed as Supplementary Notes that depend on Supplementary Note 22 with the same dependency as Supplementary Notes 113-21. Some or all of the elements described in a Supplementary Note may be applicable to various hardware, software, storage for storing software, systems, and methods.

### (Supplementary Note 1)

A computer system comprising:
hardware comprising a memory storing one or more programs, at least one processor, and a hardware accelerator, wherein
when executed by the at least one processor, the one or more programs, cause the computer system to provide an environment in which an application for providing a radio access network function runs,
the environment is adapted to allow the application to offload a weight calculation processing to the hardware accelerator,
the environment is adapted to receive from the application, in a request to offload the weight calculation processing, data and information required for the weight calculation processing to be processed by the hardware accelerator, and
the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

### (Supplementary Note 2)

The computer system according to Supplementary Note 1, wherein the data and information further contain: (c) third information indicating a second subset of radio terminals, selected from the set of radio terminals, to be considered as interference sources in the interference cancellation matrix.

### (Supplementary Note 3)

The computer system according to Supplementary Note 1 or 2, wherein the environment is adapted to notify the application of a processing capacity of the hardware accelerator or a logic processing unit associated with the hardware accelerator that is available for the weight calculation processing.

### (Supplementary Note 4)

The computer system according to Supplementary Note 3, wherein the notification of the processing capacity is performed during a configuration operation for the application to use the hardware accelerator.

### (Supplementary Note 5)

The computer system according to Supplementary Note 3 or 4, wherein the processing capacity includes a number of weight generation profiles that can be executed in parallel, as well as a matrix computing power of each weight generation profile.

### (Supplementary Note 6)

The computer system according to Supplementary Note 5, wherein the matrix computing power of each weight generation profile includes a maximum size of a computable interference cancellation matrix for each weight generation profile.

### (Supplementary Note 7)

The computer system according to Supplementary Note 6, wherein the number of weight generation profiles that can be executed in parallel and the matrix computing power of each weight generation profile are used by the application to determine one or both of the first subset of radio terminals and the subset of antennas.

### (Supplementary Note 8)

The computer system according to Supplementary Note 6, indirectly dependent on Supplementary Note 2, wherein the number of weight generation profiles that can be executed in parallel and the matrix computing power of each weight generation profile are used by the application to determine the second subset of radio terminals.

### (Supplementary Note 9)

The computer system according to any one of Supplementary Notes 1 to 8, wherein
the environment is adapted to provide an Acceleration Abstraction Layer (AAL) interface of an Open Radio Access Network (O-RAN) Cloud Platform to the application, and
the data and information are provided to the environment from the application via an Application Programing Interface (API) specific to an AAL profile.

### (Supplementary Note 10)

The computer system according to any one of Supplementary Notes 1 to 9, wherein the environment is adapted to provide the data and information to the hardware accelerator and to provide data generated by the hardware accelerator to the application.

### (Supplementary Note 11)

A method performed by a computer system, the method comprising:
providing an environment in which an application for providing a radio access network function runs; and
receiving from the application, in a request to offload a weight calculation processing, data and information required for the weight calculation processing to be processed by a hardware accelerator,
wherein the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

### (Supplementary Note 12)

One or more programs containing instructions that, when executed by a computer system, cause the computer system to perform a method, the method comprising:
providing an interface for offloading one or more processes to a hardware accelerator for an application that provides a virtualized radio access network function running on the computer system; and
receiving from the application, in a request to offload a weight calculation processing, data and information required for the weight calculation processing to be processed by the hardware accelerator,
wherein the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

### (Supplementary Note 13)

The one or more programs according to Supplementary Note 12, wherein the data and information further contain: (c) third information indicating a second subset of radio terminals, selected from the set of radio terminals, to be considered as interference sources in the interference cancellation matrix.

### (Supplementary Note 14)

The one or more programs according to Supplementary Note 12 or 13, wherein the method further comprises notifying the application of a processing capacity of the hardware accelerator or a logic processing unit associated with the hardware accelerator that is available for the weight calculation processing.

### (Supplementary Note 15)

The one or more programs according to Supplementary Note 14, wherein the notification of the processing capacity is performed during a configuration operation for the application to use the hardware accelerator.

### (Supplementary Note 16)

The one or more programs according to Supplementary Note 14 or 15, wherein the processing capacity includes a number of weight generation profiles that can be executed in parallel, as well as a matrix computing power of each weight generation profile.

### (Supplementary Note 17)

The one or more programs according to Supplementary Note 16, wherein the matrix computing power of each weight generation profile includes a maximum size of a computable interference cancellation matrix for each weight generation profile.

### (Supplementary Note 18)

The one or more programs according to Supplementary Note 17, wherein the number of weight generation profiles that can be executed in parallel and the matrix computing power of each weight generation profile are used by the application to determine one or both of the first subset of radio terminals and the subset of antennas.

### (Supplementary Note 19)

The one or more programs according to Supplementary Note 17, indirectly dependent on Supplementary Note 13, wherein the number of weight generation profiles that can be executed in parallel and the matrix computing power of each weight generation profile are used by the application to determine the second subset of radio terminals.

### (Supplementary Note 20)

The one or more programs according to any one of Supplementary Notes 12 to 19, wherein the interface includes an Acceleration Abstraction Layer (AAL) interface of an Open Radio Access Network (O-RAN) Cloud Platform.

### (Supplementary Note 21)

The one or more programs according to any one of Supplementary Notes 12 to 20, wherein the method further comprises providing the data and information to the hardware accelerator and providing data generated by the hardware accelerator to the application.

### (Supplementary Note 22)

A method performed by a computer system, the method comprising:
providing an interface for offloading one or more processes to a hardware accelerator for an application that provides a virtualized radio access network function running on the computer system; and
receiving from the application, in a request to offload a weight calculation processing, data and information required for the weight calculation processing to be processed by the hardware accelerator,
wherein the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

### (Supplementary Note 23)

One or more programs containing instructions that, when executed by a computer system, cause the computer system to perform a method, the method comprising:
sending, in a request to offload a weight calculation processing, via an interface provided by the computer system, data and information required for the weight calculation processing to be processed by a hardware accelerator,
wherein the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

### (Supplementary Note 24)

The one or more programs according to Supplementary Note 23, wherein the data and information further contain: (c) third information indicating a second subset of radio terminals, selected from the set of radio terminals, to be considered as interference sources in the interference cancellation matrix.

### (Supplementary Note 25)

The one or more programs according to Supplementary Note 23 or 24, wherein the method further comprises receiving, via the interface, a processing capacity of the hardware accelerator or a logic processing unit associated with the hardware accelerator that is available for the weight calculation processing.

### (Supplementary Note 26)

The one or more programs according to Supplementary Note 25, wherein the notification of the processing capacity is performed during a configuration operation for using the hardware accelerator.

### (Supplementary Note 27)

The one or more programs according to Supplementary Note 25 or 26, wherein the processing capacity includes a number of weight generation profiles that can be executed in parallel, as well as a matrix computing power of each weight generation profile.

### (Supplementary Note 28)

The one or more programs according to Supplementary Note 27, wherein the matrix computing power of each weight generation profile includes a maximum size of a computable interference cancellation matrix for each weight generation profile.

### (Supplementary Note 29)

The one or more programs according to Supplementary Note 28, wherein the method further comprises determining one or both of the first subset of radio terminals and the subset of antennas based on the number of weight generation profiles that can be executed in parallel and the matrix computing power of each weight generation profile.

### (Supplementary Note 30)

The one or more programs according to Supplementary Note 28, indirectly dependent on Supplementary Note 24, wherein the method further comprises determining the second subset of radio terminals based on the number of weight generation profiles that can be executed in parallel and the matrix computing power of each weight generation profile.

### (Supplementary Note 31)

The one or more programs according to any one of Supplementary Notes 23 to 30, wherein the method further comprises determining the first subset based on channel power between each radio terminal and the plurality of antennas.

### (Supplementary Note 32)

The one or more programs according to any one of Supplementary Notes 23 to 31, wherein the method further comprises selecting one or more antennas to be included in the subset of antennas in descending order of a Signal to Interference Ratio (SIR) calculated with channel power of radio terminals included in the first subset as a desired signal component and channel power of radio terminals not included in the first subset as an interference component.

### (Supplementary Note 33)

The one or more programs according to any one of Supplementary Notes 23 to 32, wherein the interface includes an Acceleration Abstraction Layer (AAL) interface of an Open Radio Access Network (O-RAN) Cloud Platform.

### (Supplementary Note 34)

A method performed by a computer system, the method comprising:
sending, in a request to offload a weight calculation processing, via an interface provided by the computer system, data and information required for the weight calculation processing to be processed by a hardware accelerator,
wherein the data and information contain at least:
   (a) first information indicating a first subset of radio terminals to which a common interference cancellation matrix applies, selected from a set of radio terminals communicating with a radio access network element; and
   (b) second information indicating a subset of antennas serving the subset of the radio terminals, selected from a set of antennas coupled to the radio access network element.

This application is based upon and claims the benefit of priority from Japanese Patent Application No. 2023-034256, filed on Mar. 7, 2023, the disclosure of which is incorporated herein in its entirety by reference.

### REFERENCE SIGNS LIST

1 Distributed Unit (DU)
2 Access Point (AP)
3 User Equipment (UE)
300 Cloud Platform
310 Cloud Platform Hardware
320 Cloud Platform Software
340 Acceleration Abstraction Layer (AAL) Interface
350 DU Function Application
601 High PHY Application
602 Acceleration Abstraction Layer (AAL)
603 Hardware Accelerator
1610 Processor
1620 Memory
1630 Mass storage
1640 Hardware Accelerator

What is claimed is:

1. A computer system comprising:
hardware comprising a memory storing one or more programs, at least one processor, and a hardware accelerator, wherein
when executed by the at least one processor, the one or more programs, cause the computer system to provide an environment in which an application for providing a radio access network function runs,
the environment is adapted to allow the application to offload a weight calculation processing to the hardware accelerator,
the environment is adapted to receive from the application, in a request to offload the weight calculation processing, data and information required for the weight calculation processing to be processed by the hardware accelerator, and
the data and information contain at least:
(a) first information indicating a first subset of radio terminals to which a common interference cancellation matrix applies, selected from a set of radio terminals communicating with a radio access network element; and
(b) second information indicating a subset of antennas serving the subset of the radio terminals, selected from a set of antennas coupled to the radio access network element.

2.-11. (canceled)

12. A non-transitory computer readable medium storing one or more programs containing instructions that, when executed by a computer system, cause the computer system to perform a method, the method comprising:
providing an interface for offloading one or more processes to a hardware accelerator for an application that provides a virtualized radio access network function running on the computer system; and
receiving from the application, in a request to offload a weight calculation processing, data and information required for the weight calculation processing to be processed by the hardware accelerator,
wherein the data and information contain at least:
(a) first information indicating a first subset of radio terminals to which a common interference cancellation matrix applies, selected from a set of radio terminals communicating with a radio access network element; and
(b) second information indicating a subset of antennas serving the subset of the radio terminals, selected from a set of antennas coupled to the radio access network element.

13.-20. (canceled)

21. A method performed by a computer system, the method comprising:
providing an interface for offloading one or more processes to a hardware accelerator for an application that provides a virtualized radio access network function running on the computer system; and
receiving from the application, in a request to offload a weight calculation processing, data and information required for the weight calculation processing to be processed by the hardware accelerator,
wherein the data and information contain at least:
(a) first information indicating a first subset of radio terminals to which a common interference cancellation matrix applies, selected from a set of radio terminals communicating with a radio access network element; and
(b) second information indicating a subset of antennas serving the subset of the radio terminals, selected from a set of antennas coupled to the radio access network element.

22. The method according to claim 21, wherein the data and information further contain: (c) third information indicating a second subset of radio terminals, selected from the set of radio terminals, to be considered as interference sources in the interference cancellation matrix.

23. The method according to claim 21, wherein the method further comprises notifying the application of a processing capacity of the hardware accelerator or a logic processing unit associated with the hardware accelerator that is available for the weight calculation processing.

24. The method according to claim 23, wherein the notification of the processing capacity is performed during a configuration operation for the application to use the hardware accelerator.

25. The method according to claim 23, wherein the processing capacity includes a number of weight generation profiles that can be executed in parallel, as well as a matrix computing power of each weight generation profile.

26. The method according to claim 25, wherein the matrix computing power of each weight generation profile includes a maximum size of a computable interference cancellation matrix for each weight generation profile.

27. The method according to claim 26, wherein the number of weight generation profiles that can be executed in parallel and the matrix computing power of each weight generation profile are used by the application to determine one or both of the first subset of radio terminals and the subset of antennas.

28. The method according to claim 26, wherein
the data and information further contain: (c) third information indicating a second subset of radio terminals, selected from the set of radio terminals, to be considered as interference sources in the interference cancellation matrix, and
the number of weight generation profiles that can be executed in parallel and the matrix computing power of each weight generation profile are used by the application to determine the second subset of radio terminals.

29. The method according to claim 21, wherein the interface includes an Acceleration Abstraction Layer (AAL) interface of an Open Radio Access Network (O-RAN) Cloud Platform.

30. The method according to claim 21, wherein the method further comprises providing the data and information to the hardware accelerator and providing data generated by the hardware accelerator to the application.
